(19) United States
(12) Patent Application Publication
(10) Pub. No.: US 2023/0246217 A1
(43) Pub. Date: Aug. 3, 2023

(54) METHODS FOR SHORT-TERM BATTERY IDLE

(71) Applicant: ESS TECH, INC., Wilsonville, OR (US)

(72) Inventors: Neal Walters Kuperman, Portland, OR (US); Yang Song, West Linn, OR (US)

(21) Appl. No.: 18/162,590

(22) Filed: Jan. 31, 2023

Related U.S. Application Data
(60) Provisional application No. 63/267,533, filed on Feb. 3, 2022.
(60) Provisional application No. 63/267,534, filed on Feb. 3, 2022.

(51) Int. Cl. H01M 8/18; H01M 4/86

(52) U.S. Cl. CPC H01M 8/188; H01M 4/8631; H01M 2004/8694

(57) ABSTRACT

Systems and methods are provided for a redox flow battery. In one example, a method for the redox flow battery includes operating the redox flow battery in a short-term idle mode by discharging the redox flow battery at a constant current density over a duration of the short-term idle mode. By discharging the current density, a plated surface at a negative electrode of the redox flow battery may be maintained.

### CROSS REFERENCE TO RELATED APPLICATIONS

The present application claims priority to U.S. Provisional Application No. 63/267,533 entitled METHODS FOR SHORT-TERM BATTERY IDLE filed Feb. 3, 2022 and to U.S. Provisional Application No. 63/267,534 entitled METHODS FOR SHORT-TERM BATTERY IDLE filed Feb. 3, 2022. The entire contents of the above identified applications are hereby incorporated by reference for all purposes.

### FIELD

The present description relates generally to a redox flow battery system.

### BACKGROUND AND SUMMARY

Redox flow batteries are suitable for grid scale storage applications due to their capabilities of scaling power and capacity independently, and charging and discharging for thousands of cycles with minimal performance losses. While idle and not actively charging or discharging, redox flow battery systems typically maintain electrolyte flow rates at a certain level in order to sustain a readiness of the system to supply power in response to a charge or discharge command.

However, the inventors herein have recognized potential issues that can arise while the redox flow battery system is maintained in an idle state. During idling, a bipolar plate of the redox flow battery system, the bipolar plate coupled to a plating electrode, may be in contact with electrolyte over a period when charge is not supplied to, or drawn from, the redox flow battery system. Namely, metal plated on the bipolar plate may crack and flake when exposed to electrolyte without active current flow. Loss of metal from the bipolar plate may cause a decrease in a charging potential of the redox flow battery system. Additionally, metal flakes lost from the bipolar plate, if not dissolved in the electrolyte, may persist and be circulated throughout the redox flow battery system. The metals flakes may contact and degrade a membrane that separates positive and negative chambers of a redox flow battery cell. Furthermore, circulation of the metal flakes may cause an electrical short, promote dendrite formation, and block electrolyte flow in the redox flow battery system.

In one embodiment, the issues described above may be addressed by a method for operating a redox flow battery system, including operating the redox flow battery system in a short-term idle mode by discharging the battery at a constant current density over the duration of the short-term idle mode, wherein discharging the battery maintains the plating surface at the negative electrode of the redox flow battery system. In this way, the plated layer at a surface of the bipolar plate coupled to a plating electrode, may be preserved, thereby allowing redox flow battery performance to be maintained and resumed after a relatively short period of battery idling.

The inventors herein provide a method for managing the surface of the bipolar plate during the short-term idle period when the bipolar plate is in contact with an electrolyte. An amount of charge stored in the redox flow battery system may be consumed during the idle period in order to minimize cracking and flaking of the plated layer at the bipolar plate surface after the idle period. In one example, the redox flow battery can be discharged and the current may flow continuously at a low current density (e.g., relative to the current density used during operation of the redox flow battery system in a discharging mode) over the duration of the short-term idle period.

In this way, the technical effect can be achieved of suppressing and mitigating the cracking and flaking of the metal plating on the bipolar plate coupled to the negative electrode of the redox flow battery after an idle period, while minimizing the amount of current sacrificed by discharging.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including the bipolar plate in contact with the negative electrode.

FIG. 2 shows a side view of an example layout for the redox flow battery system of FIG. 1

FIG. 3 shows a high level flow chart of an example of a method for operating the redox flow battery system of FIG. 1.

FIG. 4 shows a flow chart of an example of a method for determining an idle mode of the redox flow battery system.

FIG. 5 shows a flow chart of an example of a method for operating the redox flow battery system in a trickle discharge short-term idle mode.

FIG. 6A shows an image of a bipolar plate exhibiting cracking with electrolyte flow of 24 mL/min.

FIG. 6B shows a zoomed in view of the cracking at an inlet of the bipolar plate of FIG. 6A.

FIG. 6C shows an image of a bipolar plate exhibiting cracking with electrolyte flow of 120 mL/min.

FIG. 6D shows a plot of voltage as a function of time for the bipolar plates shown in FIGS. 6A and 6B.

FIG. 7A shows an image of a bipolar plate exhibiting cracking with an electrolyte temperature of 48° C.

FIG. 7B shows an example of an image of a bipolar plate exhibiting cracking with an electrolyte temperature of 60° C.

FIG. 7C shows a plot of voltage as a function of time for the bipolar plates shown in FIGS. 7A and 7B.

FIG. 8 shows an image of a bipolar plate held in an idle state for two hours without application of a trickle discharge.

### DETAILED DESCRIPTION

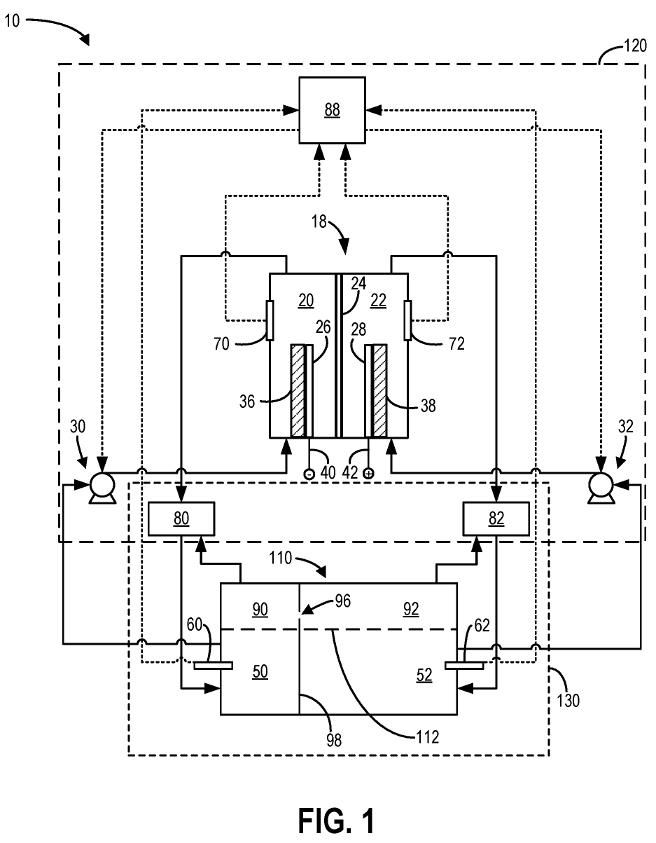

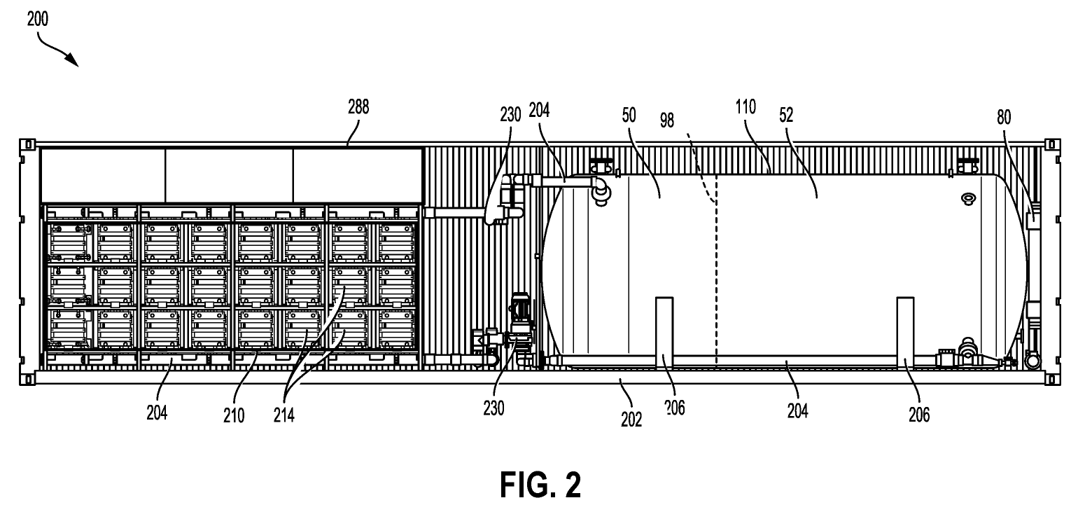

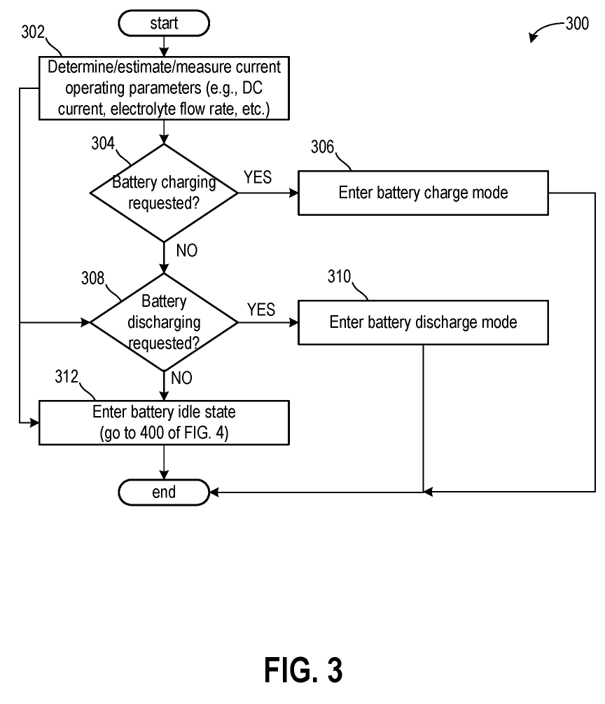

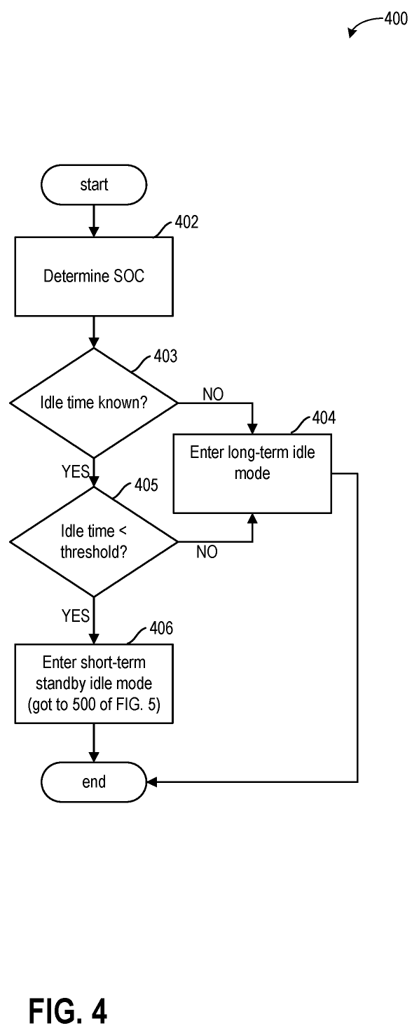

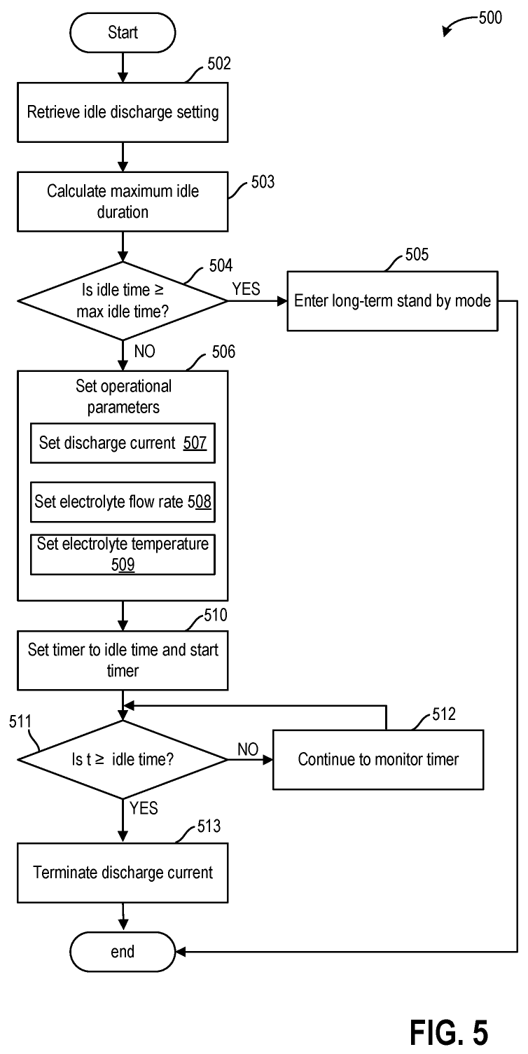

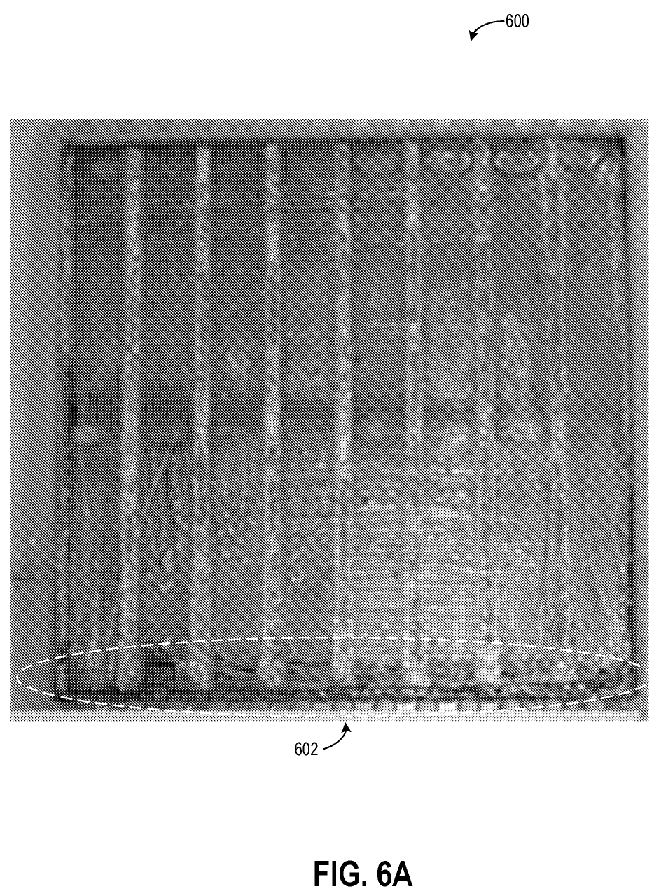

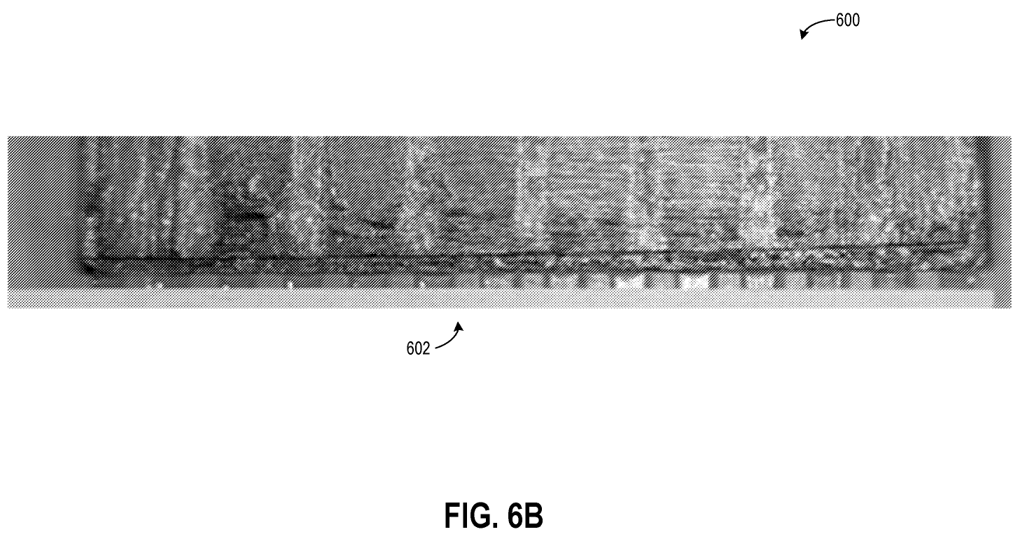

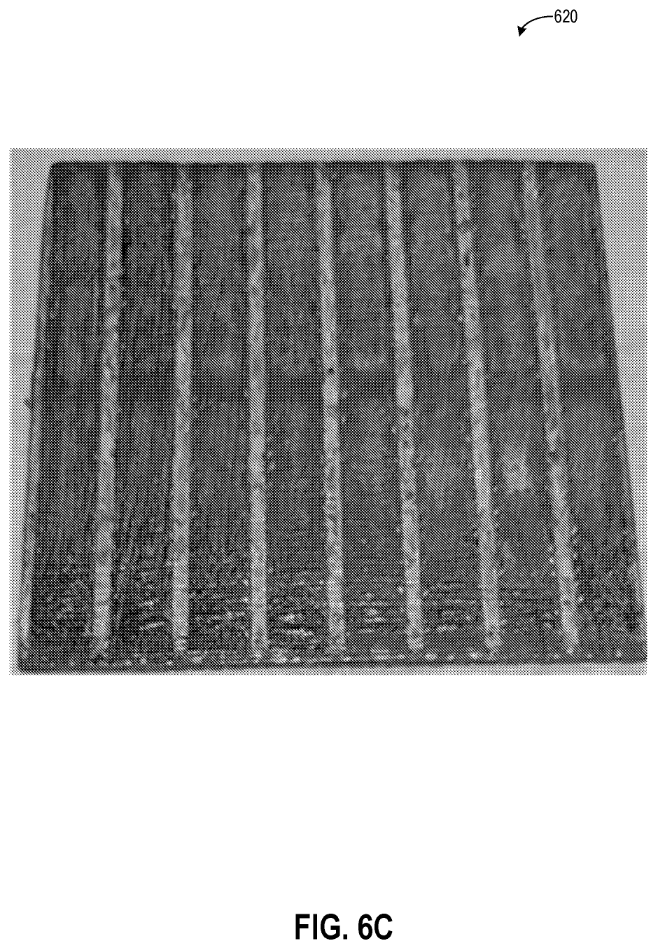

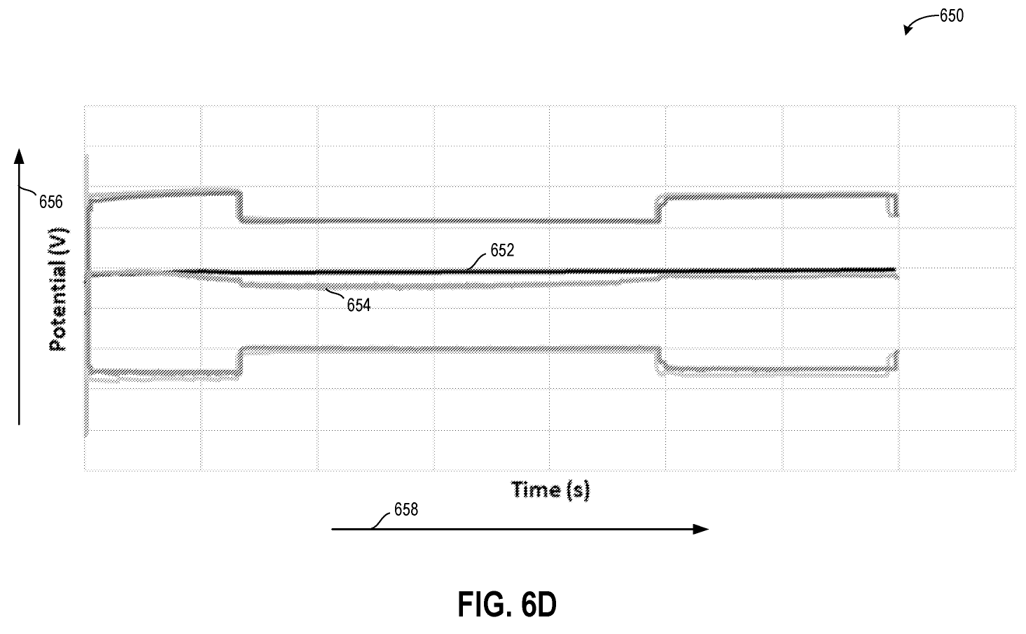

The following description relates to methods and systems for a redox flow battery. In one embodiment, a method for operating the redox flow battery during an idle state to enable surface management of plated iron is provided. For example, the method may include techniques to control a condition of plating surface to decrease a presence of defects that may degrade battery performance. The techniques may include discharging the battery at a constant current density during idling in order to maintain a quality of a surface of the plating surface of the bipolar plate that is connected to a negative electrode of the battery. FIGS. 1-2 schematically illustrate the redox flow battery and a system of more than one redox flow battery, respectively. FIG. 3 shows an example of a method for adjusting battery operation between a charging mode, a discharging mode and an idle state. Examples of methods for operating the redox flow battery in the idle state are shown in FIGS. 4-5. FIGS. 6A-8 give experimental examples of the consequences of the idle state and discharge during the idle state, including voltage versus time profiles, and images of example bipolar plate surface coatings.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metallic iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

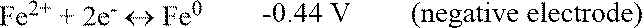

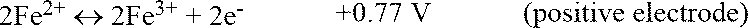

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is -0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron’s electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment.

FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, as discussed in detail with reference to FIGS. 3-5, the controller 88 may adjust the operating mode of redox flow battery system 10 according to a request or based on operating conditions, e.g., based on a SOC of the redox flow battery system 10, a load imposed on the system, etc. As one example, the controller 88 may command the redox flow battery system 10 to be placed in an idle state. The idle state may include a long-term idle mode and at least one short-term idle mode which may be selected based on operator input, for example. When placed in the short-term idle mode, strategies for surface management at the bipolar plate 36 in contact with the negative electrode 26 may be applied, as described further below.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

Turning now to FIG. 2, it illustrates a side view of an example redox flow battery system layout 200 for the redox flow battery system 10. Redox flow battery system layout 200 may be housed within a housing 202 that facilitates long-distance transport and delivery of the redox flow battery system 10. In some examples, the housing 202 can include a standard steel freight container or a freight trailer that can be transported via rail, truck or ship. The redox flow battery system layout 200 can include the integrated multi-chambered electrolyte storage tank 110 and one or more rebalancing reactors (e.g., rebalancing reactor 80) positioned at a first side of the housing 202, and a power module 210, and power control system (PCS) 288 at a second side of the housing 202. Auxiliary components such as supports 206, as well as various piping 204, pumps 230, valves (not shown at FIG. 2), and the like may be included within the housing 202 (as further described above with reference to FIG. 1) for stabilizing and fluidly connecting the various components positioned therein. For example, one or more pumps 230 may be utilized to convey electrolyte from the integrated multi-chambered electrolyte storage tank 110 to one or more redox flow battery cell stacks 214 within the power module 210. Furthermore, additional pumps 230 may be utilized to return electrolyte from the power module 210 to the negative electrolyte chamber 50 or the positive electrolyte chamber 52 of the integrated multi-chambered electrolyte storage tank 110.

Power module 210 may include one or more redox flow battery cell stacks 214 electrically connected in parallel and/or in series. Each of the one or more redox flow battery cell stacks 214 may further include a plurality of redox flow battery cells, such as the redox flow battery cell 18 of FIG. 1, connected in parallel and/or series. In this way, power module 210 may be able to supply a range of current and/or voltages to external loads. The PCS 288 includes controller 88 of FIG. 1, as well as other electronics, for controlling and monitoring operation of the redox flow battery system 10. Furthermore, PCS 288 may regulate and monitor voltage supplied to external loads, as well as supplying current and/or voltage from external sources for charging of the power module 210. The PCS 288 may further regulate and control operation of the redox flow battery system 10 during an idle state or idle mode. The redox flow battery system 10 being in an idle state may include when the power module 210 is not in a charge mode or a discharge mode. As an example, the power module 210 may be in the charge mode when an external voltage or current is supplied to one or more redox flow battery cells 18 of the power module 210 resulting in reduction of electrolyte and plating of the reduced electrolyte at the bipolar plate 36 connected to the negative electrode(s) of the one or more redox flow battery cells 18. For the case of an IFB, ferrous ions may be reduced at the plating electrode(s) of one or more redox flow battery cells 18, thereby plating iron thereat during charging of the power module 210. As another example, the power module 210 may be in the discharge mode when voltage or current is supplied from one or more redox flow battery cells 18 of the power module 210 resulting in oxidation of plated metal at the negative electrode resulting in deplating (e.g., loss of metal) and dissolving of the oxidized metal ions. For the case of an IFB, iron may be oxidized at the plating electrode of one or more redox flow battery cells 18, thereby dissolving ferrous ions thereat during discharging of the power module 210. Further details regarding conditions for entering and exiting the battery charge and discharge, and idle modes of the redox flow battery system 10 are described with reference to FIGS. 3-5.

As described above, a redox flow battery system may be placed in an idle state when not actively charging or discharging. A method for determining if a redox flow battery system is in a charging mode, discharging mode, or idle state is detailed in FIG. 3 below. The redox flow battery system may be compromised with respect to charge capacity, cycling performance, and overall electrochemical performance, when the system is left in the idle state at a non-zero state of charge. For example, in the idle state, the redox flow battery system is being neither charged nor discharged yet the electrolyte may continue to flow in order to allow the system to easily switch back to one of the charging/discharging modes. However, the quality of metal plated onto at least one surface of a bipolar plate, e.g., a bipolar plate in contact with a negative electrode of the redox flow battery system, may be adversely affected when electrolyte is flowing but no current is passing to or from the bipolar plate. For example, the plated metal (e.g., the plating layer) may crack, and in some examples, may flake off into an electrolyte of the redox flow battery system, which may be distributed through the redox flow battery system, increasing a likelihood of contact between the metal flakes and a membrane separator, such as the separator 24 of FIG. 1. In some examples, such contact may degrade the membrane separator. Furthermore, cracks in the plated metal may increase the likelihood of dendrite formation, which increases a likelihood of short circuiting a cell.

The issues described above may be exacerbated as idling period increases. For example, when a charging cycle of a redox flow battery cell is interrupted and undergoes a period of time where the system is not charging, but electrolyte continues to flow, e.g., a short-term idle mode, cracking of the plated metal may be pronounced when charging of the redox flow battery is resumed. In one example, when the redox flow battery system operation is adjusted to the short-term idle mode, as shown in FIG. 4, the quality of the plating at the bipolar plate may be preserved by discharging the battery at a constant current density, while also maintaining other redox flow battery system components (e.g., electrolyte, pumps, etc.) in a state that may easily be switched to a charging or discharging mode. A method for maintaining a constant discharge current during the idle period, hereafter referred to as a trickle discharge, to discharge the battery throughout the idle period, is shown in FIG. 5. The trickle discharge current may be less than a discharge current during a discharge cycle of the redox flow battery. Conditions and operational parameters implementing the short-term idle mode are described further below.

Referring now to FIG. 3, a method 300 for operating a redox flow battery system is depicted. For example, the redox flow battery system may be operated in a charging mode, discharging mode, or idle state. Instructions for carrying out method 300, and the rest of the methods included herein, may be executed by a controller, such as the controller 88 of FIG. 1, based on executable instructions stored on a non-transitory memory of the controller and in conjunction with signals received from sensors of the redox flow battery system, such as the sensors described above with reference to FIG. 1. The controller may employ actuators of the redox flow battery system to adjust battery operation, according to the methods described below.

The method 300 may begin at 302, where the method includes determining, estimating, and/or measuring current battery operating parameters. Current battery operating parameters may include, but are not limited to, one or more of battery state of charge (SOC), power module voltage, DC current, pump activity (e.g., electrolyte pump ON/OFF statuses, electrolyte pump flow rates, pump timers, and the like), electrolyte temperatures, power (including current and voltage) supplied to the power module, power (including current and voltage) supplied by the power module, internal power demand set points, and external power demand set points, and the like.

At 304, the method 300 includes confirming if a request for charging of the redox flow battery system is received. Receiving the request may indicate that the redox flow battery system is currently being charged or in a charging mode or that adjustment of the redox flow battery systems to the charging mode from a different operating mode is desired. The redox flow battery system being in the charging mode may include one or more redox flow battery cells of the redox flow battery system being in the charging mode. The charging mode may be indicated by a set point or desired SOC for one or more redox flow battery cells being greater than an actual SOC for the one or more redox flow battery cells. In another example, the charging mode may be indicated by the desired SOC being greater than the actual SOC by more than a charging threshold SOC difference. Additionally, or alternatively, the redox flow battery system may be charging when a DC current from the power module is positive. In one example, DC current may be positive when current is flowing into the power module from an external power source. The DC current magnitude and direction may be measured by determining the voltage drop across a shunt resistor electrically connected with the power module.

In an alternate example, a redox flow battery system being in the charging mode may be indicated by a supply of power (including a supply of current and/or voltage) to the power module being greater than a charging threshold supply of power. The charging threshold supply of power may refer to a rate of power supply to the redox flow battery system greater than an incidental or auxiliary rate of power supply to the power module used for powering sensors, lighting, and other auxiliary devices related to the power module. In this way, supplying power greater than the threshold supply of power indicates that current is being supplied directly to one or more plating electrodes, resulting in reduction of metal ion at the plating electrode surface and plating of the reduced metal thereat. Similarly, the charging mode may be indicated by SOC of one or more redox flow battery cells increasing at a rate greater than a threshold rate of SOC increase as a result of supplying power to the redox flow battery system during charging.

In another example, determination of the redox flow battery system being in the charging mode may be based on a flow rate of electrolyte being supplied to one or both of the negative and positive electrolyte chambers of a redox flow battery cell being greater than a charging threshold flow rate. The first threshold (negative or positive electrolyte) flow rate may refer to a flow rate that is greater than a flow rate of a pump used for electrolyte recirculation during an idle state. Pumping the electrolyte at a flow rate greater than the charging threshold flow rate may enable the flow rate of electrolyte being supplied to the negative and positive electrolyte chambers to be high enough to sustain a desired charging rate. The rate of supply of electrolytes may thus be related to the stoichiometry of the redox reactions occurring at the redox flow battery cell electrodes. As an idealized simple example, in the case of an IFB, for every two electrons supplied during charging at the negative electrode, one ferrous ion is supplied to the negative electrolyte chamber for reduction thereat, and two ferric ions are supplied at the positive electrolyte chamber for oxidation thereat. In this way the electrolyte flow rates and the charging threshold electrolyte flow rates to each of the positive and negative electrolyte chambers corresponding to operation in a charging mode may be unequal. Furthermore, electrolyte flow rates in excess of the idealized stoichiometric flow rates may be supplied to the redox flow battery cell to support a desired charging rate to account for non-ideal mixing and losses within the system.

As a further example, while charging, the ionic species in the positive and negative electrode compartments 22 and 20 may be changing at rates characteristic of being in the charging mode or may attain steady-state values (relative to an electrolyte pumping rate) associated with the charging mode. For example, during charging, plating of ferrous ion may result in a characteristic decrease (or characteristic rate of decrease) in ferrous ion concentration in the negative electrolyte compartment. Similarly, the concentration (or rate of change in concentration) of other ionic species such as ferric ion, chloride ion, hydrogen protons (e.g. pH), and other species may be characteristic of operating the redox flow battery cell in the charging mode. Furthermore, other electrolyte properties such as ionic strength, pH, and the like may have characteristic steady-state values or rates of change that can be used to indicate the redox flow battery system being in the charging mode. In other words, the controller may estimate and/or measure one or more species concentrations (or rate of change thereof), including measuring a pH and/or ionic strength, and determine, based on one or a combination of those measurements being beyond a charging threshold value characteristic to operation in the charging mode, if the redox flow battery system is in the charging mode. Furthermore, the controller may determine that the redox flow battery system is in the charging mode based on a rate of power supply to the power module, a measured DC current by way of a voltage drop across a shunt resistor electrically connected to the power module, a rate of increase in SOC, a difference between a desired and actual SOC, and/or a flow rate of electrolytes to one or more redox flow battery cells, as described above.

In further examples, operation of the redox flow battery system may be adjusted to the charging mode when a SOC of one or more of the redox flow battery cells has discharged below a lower threshold SOC. The lower threshold state of charge may include when the redox flow battery cell has been fully depleted of charge. In another example, the lower threshold state of charge may correspond to a SOC below which a risk of degradation of the redox flow battery cell may be increased. Other conditions for entering or beginning a charging mode may include when a desired power from an external load is greater than the available power from the redox flow battery system by more than a threshold power difference. Thus, the controller may also determine that the redox flow battery system is in the charging mode when a condition for entering or beginning the charging mode is met.

Upon confirming that the request for the charging mode is received, method 300 continues to 306 to initiate or resume/continue charging of the redox flow battery system. As described above, charging the redox flow battery system may include operating an electrolyte pump (e.g., one or more of negative positive electrolyte pumps 30 and 32 of FIG. 1) to flow electrolytes to redox flow battery negative and positive electrolyte chambers at charging negative and positive threshold flow rates, respectively. In another example, the controller may command power to be supplied to the power module at a level greater than a charging threshold supply of power in order to raise an actual SOC of one or more of the redox flow battery cells to a desired SOC. Raising the SOC of one or more of the redox flow battery cells to a desired SOC may include increasing the SOC by a rate of SOC increase greater than the charging threshold rate of SOC increase. Furthermore, the controller may instruct one or more actuators to be activated in order to maintain one or more of a combination of electrolyte species concentrations, pH, ionic strength, and other electrolyte characteristics at a desired value that may correspond to the redox flow battery system being in the charging mode. In one example the desired values may include being beyond a threshold value characteristic to operation of the redox flow battery system in the charging mode.

If the redox flow battery system is not being charged, then the method 300 proceeds from 304 to 308 to confirm if a request for discharging of the redox flow battery system is received. Receiving the request for discharging may indicate that the redox flow battery system is in a discharge mode or adjustment of the redox flow battery system to the discharge mode is desired. The redox flow battery system being in the discharge mode may include one or more redox flow battery cells of the redox flow battery system being in the discharge mode. The discharge mode may be indicated by the set point or desired SOC for one or more redox flow battery cells being less than the actual SOC for the one or more redox flow battery cells. In another example, the discharge mode may be indicated by the desired SOC being less than the actual SOC by more than a threshold difference.

In one example, the redox flow battery system being in the discharge mode may be indicated by the supply of power (including the supply of current and/or voltage) from the power module to an external load being greater than the charging threshold supply of power. The charging threshold supply of power may refer to the rate of power supply from the redox flow battery system to an external load being greater than an incidental or auxiliary rate of power supply to the power module used for powering sensors, lighting, and other auxiliary devices related to the power module. In this way, supplying power from the power module greater than the charging threshold supply of power indicates that current is being supplied directly to the external load, resulting in oxidation of metal plated at the plating electrode surface to metal ion and solubilizing the metal ion into the negative electrolyte compartment. Similarly, the discharge mode may be indicated by the SOC of one or more redox flow battery cells decreasing at a rate greater than a threshold rate of SOC decrease as a result of supplying power from the redox flow battery system during discharge.

Additionally, or alternatively, the redox flow battery system may be in the discharge mode when the DC current from the power module is negative. In one example, DC current may be negative when current is flowing out of the power module to an external load. As described above, the DC current magnitude and direction may be determined by measuring the voltage drop across a shunt resistor electrically connected to the power module.

In another example, determination of the redox flow battery system being in the discharge mode may be based on a flow rate of electrolyte being supplied to one or both of the negative and positive electrolyte chambers of a redox flow battery cell being greater than a discharge threshold flow rate. The discharge threshold (negative or positive electrolyte) flow rate may refer to a flow rate that is greater than a flow rate of a pump used for electrolyte recirculation during an idle mode. Pumping the electrolyte at a flow rate greater than the discharge threshold flow rate may enable the flow rate of electrolyte being supplied to the negative or positive electrolyte chambers to be high enough to sustain a desired redox flow battery system discharge rate. The rate of supply of electrolytes may thus be related to the stoichiometry of the redox reactions occurring at the redox flow battery cell electrodes. As an idealized simple example, in the case of an IFB, for every two electrons supplied from the redox flow battery system during discharge at the negative electrode, one ferrous ion is oxidized, and two ferrous ions are supplied at the positive electrolyte chamber for reduction thereat. In this way the electrolyte flow rates and the discharge threshold electrolyte flow rates to each of the positive and negative electrolyte chambers corresponding to operation in the charging mode may be unequal. Furthermore, electrolyte flow rates in excess of the idealized stoichiometric flow rates may be supplied to the redox flow battery cell to support a desired discharge rate to account for non-ideal mixing and losses within the system.

As a further example, while in the discharge mode, the ionic species in the positive and negative electrode compartments 22 and 20 may be changing at rates characteristic of being in the discharge mode or may attain steady-state values (relative to an electrolyte pumping rate) associated with the discharge mode. For example, during discharge, plating of ferrous ion may result in a characteristic decrease (or characteristic rate of decrease) in ferrous ion concentration in the negative electrolyte compartment. Similarly, the concentration (or rate of change in concentration) of other ionic species such as ferric ion, chloride ion, hydrogen protons (e.g. pH), and other species may be characteristic of operating the redox flow battery cell in the discharge mode. Furthermore, other electrolyte properties such as ionic strength, pH, and the like, may have characteristic values or rates of change that can be used to indicate the redox flow battery system being in the discharge mode. In other words, the controller may estimate and/or measure one or more species concentrations (or rate of change thereof), including measuring a pH and/or ionic strength, and determine, based on one or a combination of those measurements being beyond a threshold value characteristic to operation in the discharge mode, if the redox flow battery system is in the discharge mode. Furthermore, the controller may determine the discharge mode based on a rate of power supply to the power module, a rate of increase in SOC, a difference between a desired and actual SOC, and/or a flow rate of electrolytes to one or more redox flow battery cells, as described above.

In further examples, the controller may enter the discharge mode when the SOC of one or more of the redox flow battery cells has charged above a higher threshold SOC. The higher threshold state of charge may include when the redox flow battery cell has been fully charged to capacity. In another example, the higher threshold state of charge may correspond to a SOC above which a likelihood of overcharging and degradation of the redox flow battery cell may be increased. Other conditions for entering or beginning the discharge mode may include when an actual power supplied from the redox flow battery system to an external load is less than the desired power by more than a discharge threshold power difference. Thus, the controller may also determine that the redox flow battery system is in the discharge mode when a condition for entering or beginning the discharge mode is met.

Upon confirming the request for the discharge mode is received, method 300 continues from 308 to 310 to initiate or resume/continue the discharge mode of the redox flow battery system. As described above, discharge of the redox flow battery system may include operating the electrolyte pump (e.g., one or more of negative and positive electrolyte pumps 30 and 32 of FIG. 1) to flow electrolytes to redox flow battery negative and positive electrolyte chambers at discharge negative and positive threshold flow rates, respectively. In another example, the controller may command power to be supplied from the power module to an external load greater than the discharge threshold supply of power in order to lower the actual SOC of one or more of the redox flow battery cells to a desired SOC. Lowering the SOC of one or more of the redox flow battery cells to the desired SOC may include lowering the SOC by a rate of SOC decrease greater than the threshold rate of SOC decrease. Furthermore, the controller may instruct one or more actuators to be operated in order to maintain one or more of a combination of electrolyte species concentrations, pH, ionic strength, and other electrolyte characteristics at a desired value that may correspond to the redox flow battery system being in the discharge mode. In one example, the desired values may include being beyond a threshold value characteristic to operation of the redox flow battery system in the discharge mode.

If the request for operating the redox flow battery system is the discharge mode is not received, method 300 continues at 312 to place the redox flow battery system in an idle state or maintain the operating mode of the redox flow battery system if the system is already in the idle state. In one example, the redox flow battery may be in the idle state when the DC current from the power module is less than or substantially equal to an idle threshold current. In one example, the idle threshold current may be zero. In another example, as described further below, the idle threshold current may be a non-zero value. Method 300 continues to method 400 to determine an idle mode for the redox flow battery system, where the idle mode may be a sub-state of the idle state.

Turning now to FIG. 4, it shows a method 400 for selecting the idle mode when the redox flow battery system is adjusted to the idle state, as described above for method 300 of FIG. 3. The idle state of the redox flow battery may also be referred to as a standby state. Method 400 may begin following 312 of method 300 of FIG. 3, when the redox flow battery system enters the idle state.

The method 400 begins at 402, where the controller estimates and/or measures the battery state of charge (SOC). The SOC may be determined based on a signal from one or more sensors of the redox flow battery system, such as a signal from a hydrometer, voltage and/or current measurements, modeling of the battery system with a Kalman filter applied, etc. At 403, the method 400 includes determining if a duration of an idle period, e.g., a target period of time where the redox flow battery system is in the idle state, is known. For example, information regarding a desired length of time of the idle period may be provided by user input at a user interface of the controller. The user may input an idle time of up to a maximum idle time, which may be determined based on the current SOC, as described below with reference to FIG. 5. The known idle time may be referred to as a set idle duration.

If the idle time is not known (said another way, the set idle duration is unknown), the method proceeds to 404 to enter a long-term idle mode. Entering the long-term idle mode may include adjusting the redox flow battery system actions to preserve electrolytes and battery components without accounting for requests to quickly enter the charge or discharge mode. Still further, the electrodes may be preserved by purging the chamber with either argon or hydrogen gas. Still further, the long-term idle mode may include powering down the power components of the redox flow battery such as electrolyte heaters and electrolyte pumps.

In yet other examples, the long-term idle mode may include adjusting various settings of the redox flow battery system in addition to or instead of the long-term idle mode strategies described above. For example, the electrolyte may be completely drained from the redox flow battery if a long-term idle mode is expected.

If the duration of the idle period is known, the method continues to 405 to determine if the known idle period is less than a threshold. For example, the threshold may be a duration of time associated with an amount of charge (e.g., coulombs) representative of an amount of iron plated at a negative electrode and bipolar plate of the redox flow battery system, such as the negative electrode 26 and the bipolar plate 36 of FIG. 1. The amount of charge from plating may be predicted based on an overall amount of charge plated (in Coulombs) at the negative electrode and a known plating efficiency of the redox flow battery system, where the known plating efficiency is determined based on a surface area of the negative electrode and the bipolar plate. The known idle time (in units of seconds) may be converted to an estimated amount of charge (e.g., C_{idle}), in coulombs, that may be discharged from the negative electrode and bipolar plate using an idle period set discharge current density (in units of mA/cm²) and active plating area (in units of cm²), according to equation 3 below.

$$\left(\text{Known idle time}\right) * \left(\text{trickle discharge current}\right) * \left(\text{active area}\right) = {\text{C}}_{\text{idle}}$$

The idle period set discharge constant current density, e.g., 4.0 mA/cm², also referred to herein as a trickle discharge current, may be selected based on a demonstrated capability of the discharge current magnitude to mitigate poor plating quality subsequent to a period of idling, as described further below, with reference to FIG. 5. The trickle discharge allows a small amount of current to flow from the negative, plating electrode to a positive electrode of the redox flow battery system. In an IFB, during application of trickle discharge, Fe⁰ is oxidized to Fe²⁺ on the bipolar plate connected to the plating electrode. The trickle discharge current density may be between 1 mA/cm² - 10 mA/cm², 2 mA/cm² - 6 mA/cm², or 3.5 mA/cm² - 5.5 mA/cm², for example. In one example, a preferred range of the trickle discharge may be 3.5 mA/cm² -5.5 mA/cm².

The estimated value of C_{idle} may be compared to the amount of charge from available plating. If the known idle time corresponds to a C_{idle} value greater than or equal to the amount of charge available from plating, the estimated amount of plating at the bipolar plate is not sufficient for maintaining the trickle discharge over the known duration of the idle period, the idle time is determined to be greater than the threshold. The method 400 proceeds to 404 to enter the long-term idle mode, as described above. If the idle period corresponds to a value that is less than the amount of charge from plating, the estimated amount of plating is sufficient to maintain the trickle discharge over the known duration of the idle period, the idle time is determined to be less than the threshold and the method 400 continues to 406 to enter a short-term idle mode, as described below with reference to FIG. 5.

Turning now to FIG. 5, it shows the method 500 for operating the redox flow battery system in the short-term idle mode. The method 500 follows from 406 of FIG. 4.

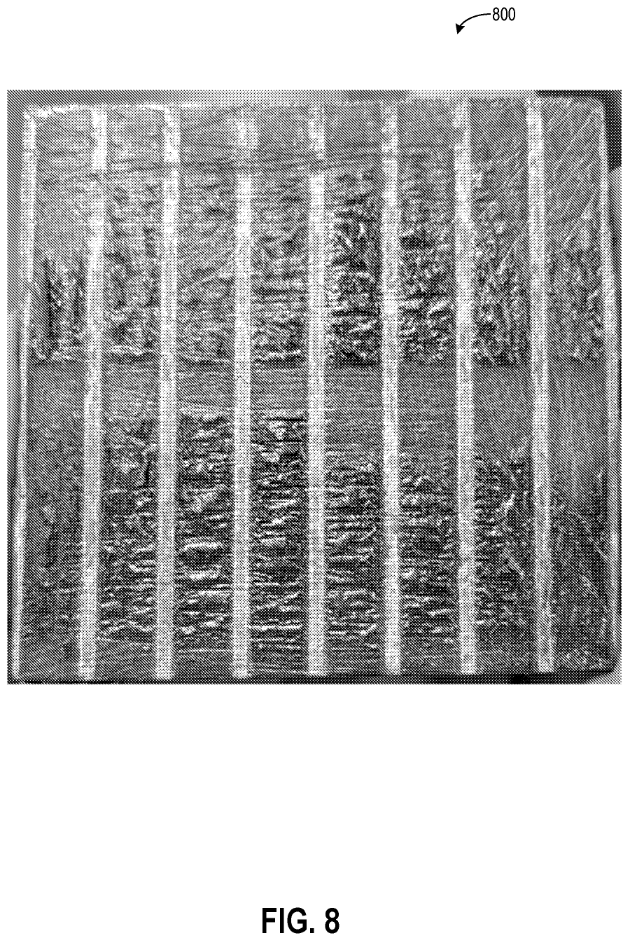

The method 500 depicts a surface management strategy of the plating surface at the bipolar plate corresponding to the negative electrode based on application of the trickle discharge current over the duration of the short-term idle period. During the trickle discharge, metal plated at the bipolar plate connected to the plating (e.g., negative) electrode is oxidized. The plated metal may be Fe⁰ if the redox flow battery is an IFB. The trickle discharge current density may be set to ensure cracking of the metal plated on the bipolar plate is mitigated upon resumption of charging conditions. The trickle discharge current density may further be selected to minimize the amount of capacity lost through discharging during the idle period while still preserving the plated surface quality of the bipolar plate. Possible ranges for the trickle discharge current density are provided above, with reference to FIG. 4. In one example, the trickle discharge current density may be 4 mA/cm². In an alternate example, when the idle time is less than 2 hours, a trickle discharge density of 0 mA/cm² may be desired. For example, an example of a bipolar plate left in an idle state for one and half hours without a trickle discharge is shown in FIG. 8, with even and continuous plating exhibited across a surface of the bipolar plate.

At 502, the method 500 includes retrieving an idle discharge setting, e.g., a pre-set idle discharge setting stored in a memory of the controller. For example, the controller may refer to a look-up table depicting relationships between a current battery SOC and an amount of coulombs to be discharged, where the amount may be a target percentage of the SOC. As another example, the charge density may be input by a user through a user interface.

At 503, method 500 includes calculating the maximum idle duration. The maximum idle duration is determined by dividing the coulombs plated, as determined from the known plating efficiency, by the idle discharge current set in the idle discharge setting at 502. In other words, equation 3 is solved for idle time given an idle discharge current and where C_{idle} is coulombs plated. At 504, method 500 includes comparing the maximum idle duration to the known idle duration. If the known idle duration is greater than or equal to the maximum idle duration, the method continues to 505 to enters a long-term idle mode as described above with reference to FIG. 4. The method 500 ends.

If the known idle duration is less than the maximum idle duration, than the method continues to 506 to set operational parameters corresponding to the short-term idle mode, including setting a discharge current density at 507, setting an electrolyte flow rate at 508, and setting an electrolyte temperature at 509. The discharge current density may be set to the trickle discharge current density setting retrieved at 502.

Setting the electrolyte flow rate at 508 and setting the electrolyte temperature at 509 may include repeatedly cycling operation of an electrolyte pump between an active state and inactive state. For example, the flow rate can be cycled from zero flow up to a maximum possible flow rate. The electrolyte temperature range may include a low temperature set at ambient, e.g., room temperature up to a highest temperature that maintains an integrity of the electrolyte. When in the active state, the electrolyte pump may drive electrolyte flow through the redox flow battery system at an idling threshold flow rate. When the electrolyte pump is in the inactive state, the electrolyte pump may be deactivated and an electrolyte heater set point may be decreased. The electrolyte heater set point may be decreased to room temperature. By cycling the electrolyte pump, the redox flow battery system may be maintained responsive to charging and discharging commands while in the idle state and parasitic power losses, such as due to pumping, heating, and shunt currents, may be reduced.

Setting the electrolyte temperature may further include setting the electrolyte temperature to a set point which reduces power loss of the redox flow battery while in the short-term idle mode. A minimum idle threshold temperature may be based on a solubility or stability of the electrolyte during the short-term idle mode. For example, below the idle threshold temperature, a likelihood of destabilizing the electrolyte may be increased. Destabilization of the electrolyte may include precipitation of electrolyte salts, which reduces the redox flow battery system capacity and performance.

At 510, the method 500 includes setting a timer to the known idle duration and starting the timer. The method 500 includes confirming if a duration of time elapsed since starting the timer reaches or passes the known idle time. If the elapsed time, as monitored by the timer, is less than the known idle time, the method 500 proceeds to 512 to continue monitoring the timer and to maintain the operational parameters set at step 506. While maintaining the discharge current set at 507, a corresponding amount of metal is sacrificed from the negative electrode. Method 500 returns to 511. If, at 511, the elapsed time is equal to or greater than the known idle time, the method 500 continues to 513 and includes terminating the discharge current. The method 500 ends.

Degradation of plating quality during an idle period may occur over a wide range of operational parameters with respect to electrolyte flow rate and temperature. For example, redox flow batteries were tested to assess effects of operating parameters on plating quality on the negative electrode bipolar plate of the cells. The type, volume, and pH of the battery negative and positive electrolytes were kept constant while other operating parameters were varied. Experimental settings of the redox battery cells included electrolyte temperature, ranging from 48° C. to 60° C. The electrolyte flow rate was varied between 24 mL/min to 120 mL/min. The charging current density was varied between 29 mA/cm² to 45 mA/cm². With respect to idle period, the duration of the idle period was varied from 30 min to 6 hours and the discharge current density was varied from 0 mA/cm² to 5.0 mA/cm². It may be appreciated that the above parameters are given as possible examples and many other combinations of operational parameters may be embodied.

The impact of idle conditions on plating quality at the negative electrode and overall flow battery health were determined by charging a battery to a preset SOC, then stopping charging and placing the battery in an idle mode with target operating parameters, and then resuming charging to a preset final SOC. After charging the redox flow battery to the final SOC, the plating on the negative bipolar plate was examined for signs of distress.

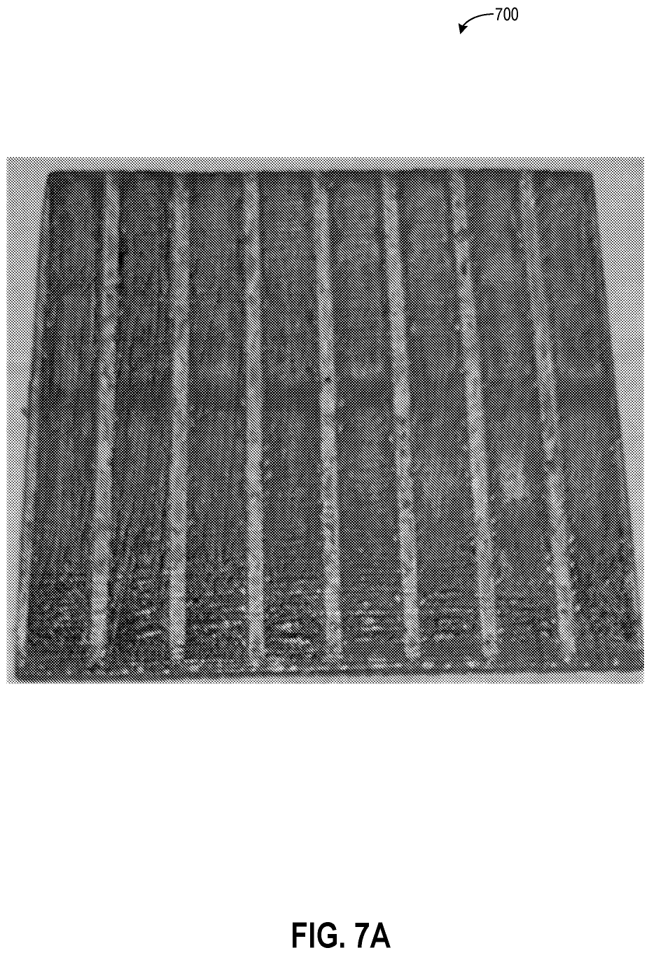

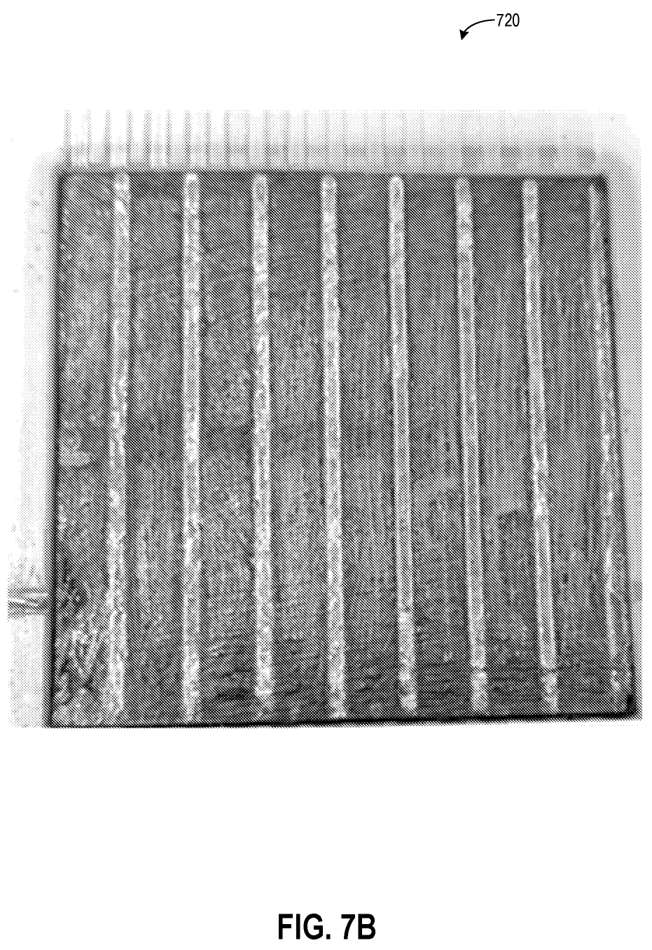

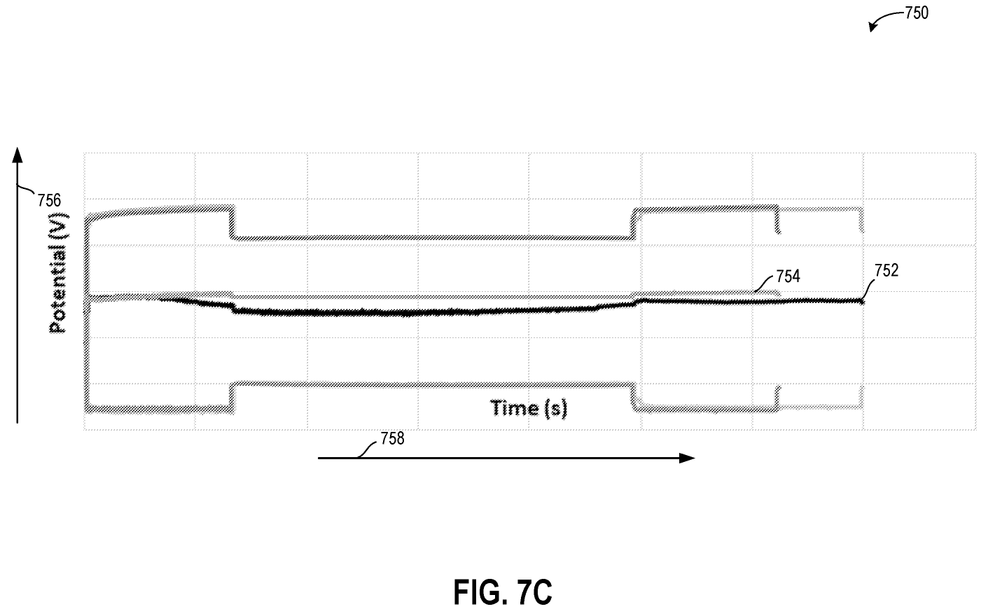

Example experimental results are depicted in FIGS. 6A-8 for evaluating the effect of application of a trickle discharge current density. Results shown in FIGS. 6A-D and FIGS. 7A-C indicate a lack of sensitivity of the bipolar plate coating to other redox flow battery operating conditions besides the discharge current. Thus, other operating conditions may be optimally set during short-term idling of a redox flow battery system to reduce parasitic current loss or increase battery readiness for operation in other modes, for example.

Plating electrodes were tested at two different electrolyte flow rates, including a lower flow rate and a higher flow rate. Electrolyte flow rate may be as low as 0 mL/min (e.g. no electrolyte flow) up to the maximum recommended flow rate for the redox flow battery system. Degradation of plating quality after being in an idle state for 2 hours with zero discharge current density was demonstrated to be similar regardless of electrolyte flow rate.

Effects of electrolyte flow rate on plating quality are demonstrated in images of a first bipolar plate 600 of FIG. 6A exposed to the lower electrolyte flow rate. A closer view of the inlets 602 where most of the plate degradation was observed is shown in FIG. 6B. A second bipolar plate 620 is shown in FIG. 6C, the second bipolar plate 620 exposed to the higher electrolyte flow rate. A graph 650 plotting changes in voltage over time, e.g., voltage profiles, for the bipolar plates shown in FIGS. 6A-C is shown in FIG. 6D. An arrow 656 corresponds to a direction of increasing potential on the y-axis of graph 650. An arrow 658 corresponds to direction of increasing elapsed time on the x-axis of graph 650. A first plot 652 corresponds to the first bipolar plate 600 of FIG. 6A and a second plot 654 corresponds to the second bipolar plate 620 of FIG. 6B. The first plot 652 and the second plot 654 are similar and overlap, indicating a similar electrochemical performance.

Bipolar plates were also tested at the two different electrolyte temperatures including a lower temperature and a higher temperature. As described above, the electrolyte temperature may be a temperature within a range between room temperature up to the maximum temperature that maintains a stability of the electrolyte during the short-term idle period. The bipolar plates were maintained in the idle state for 2 hours with zero current discharge for tests conducted at each electrolyte temperature. Examples of the bipolar plates after testing under the above conditions are shown in FIGS. 7A and 7B.

A first bipolar plate 700, tested at the lower temperature is depicted in FIG. 7A, demonstrating cracking at channel inlets of the bipolar plate as well as initial evidence of cracking within the channels. A second bipolar plate 720 is shown in FIG. 7B, tested at the higher temperature, showing cracking throughout the second bipolar plate 720. A graph 750 plotting voltage vs time (e.g., voltage profiles) is depicted in FIG. 7C for each of the bipolar plates shown in FIGS. 7A and 7B, the bipolar plates each tested in a redox flow battery cell according to the conditions described above. For example, plot 752 of graph 750 represents the voltage profile of the bipolar plate shown in FIG. 7A and plot 754 shows the voltage profile of the bipolar plate shown in FIG. 7B. An arrow 756 corresponds to a direction of increasing potential on the y-axis of graph 750. An arrow 758 corresponds to direction of increasing elapsed time on the x-axis of graph 750. As shown in graph 750, the voltage profiles of the bipolar plates overlap, indicating similar performances at both electrolyte temperatures.

Plating degradation at the bipolar plate was also evaluated over different durations of time in the idle state. Plating quality was tested for idle times of 1 hour and 1.5 hours while varying other parameters as described above with reference to FIGS. 6A-7C. When idle time was held at 1.5 hours or less, there was no sign of plating degradation, even when the trickle discharge current density was zero. However, all tests covering different operating conditions where the idle time was 2 hours or greater, resulted in degradation of the deposited metal on the bipolar plate when the trickle discharge current density was zero.

A relationship between a density of a trickle discharge current and a surface quality of a bipolar plate was also determined experimentally. Discharge currents from 0 mA/cm² up to 5 mA/cm² were tested. At lower current densities, such as 1 mA/cm², some plating damage may still occur, despite the applied trickle discharge current. Tests showed that discharge currents greater than or equal to 4 mA/cm² may be more effective for preventing plating surface damage during an idle period. Turning now to FIG. 8, a third bipolar plate 800 is shown, where the third bipolar plate 800 was maintained in an idle state for two hours without a trickle discharge current applied. The third bipolar plate 800 exhibits blistering and flaking. The degradation observed at the third bipolar plate 800 confirms that without the trickle discharge current, cracking and/or flaking may occur with varying levels of severity, as demonstrated by FIGS. 6B, 7A and 8. The cracking and/or flaking may be mitigated using a sufficiently high trickle discharge current during the idle period.

The technical effect of short-term idle method described in method 400 and method 500 is to maintain a performance of a redox flow battery system after a short-term idling period by allowing the system to discharge a current over the short-term idling period. In particular, when operation of the redox battery system in a charging mode is interrupted and the operation is adjusted to an idle state for a relatively short period of time, such as two hours, cracking and flaking of a plated layer of metal at a bipolar plate is suppressed. At least one surface of the bipolar plate may be electrically coupled to a negative, or plating electrode of the redox flow battery system and the plated layer of metal may contribute to an overall charge capacity of the redox flow battery system after completion of a charge cycle. By discharging the battery during the short-term idling period, the plated layer may be maintained intact, thereby alleviating issues associated with cracking at the plated layer and distribution of metal flakes through the redox flow battery system, such as short circuiting, dendrite formation, membrane degradation, and electrolyte blockages. Discharging the current may include sacrificing a relatively small amount of the charge capacity, corresponding to an amount of metal plated at the bipolar plate, which may occur continuously over the duration of the short-term idling period as a trickle discharge current. The method of discharge may provide low-cost, efficient strategies to maintain the performance of the redox flow battery system.

The disclosure also provides support for a method for a redox flow battery, comprising: operating the redox flow battery in a short-term idle mode by discharging the redox flow battery at a constant current density over a duration of the short-term idle mode, wherein discharging the redox flow battery maintains a plating surface at a negative electrode of the redox flow battery. In a first example of the method, operating the redox flow battery in the short-term idle mode includes adjusting an operating mode of the redox flow battery to a state where the redox flow battery is not charging or discharging. In a second example of the method, optionally including the first example, operating the redox flow battery in the short-term idle mode includes adjusting operation of the redox flow battery to an idle state for a set idle duration. In a third example of the method, optionally including one or both of the first and second examples, adjusting operation of the redox flow battery to the idle state for the set idle duration includes operating the redox flow battery in the idle state for a duration equal to or less than 6 hours. In a fourth example of the method, optionally including one or more or each of the first through third examples, adjusting operation of the redox flow battery to the idle state includes adjusting an electrolyte temperature and adjusting an electrolyte flow rate. In a fifth example of the method, optionally including one or more or each of the first through fourth examples, discharging the redox flow battery at the constant current density includes discharging current at a current density lower than a current density of current discharge used during operation of the redox flow battery in a discharge mode. In a sixth example of the method, optionally including one or more or each of the first through fifth examples, discharging the redox flow battery at the constant current density includes discharging at a current density between 0 mA/cm2 and 5 mA/cm2. In a seventh example of the method, optionally including one or more or each of the first through sixth examples, discharging the redox flow battery at the constant current density includes sacrificing a corresponding amount of metal plated at the negative electrode.

The disclosure also provides support for a redox flow battery system, comprising: a battery cell including a negative electrode, a positive electrode, and an electrolyte, a bipolar plate electrically coupled to the negative electrode having a layer of plated metal over at least one surface of the bipolar plate, and a controller, including executable instructions stored on non-transitory memory that, when executed, cause the controller to: continuously discharge a current density in response to operation of the redox flow battery system in a short-term idle mode. In a first example of the system, the bipolar plate is configured to receive a metal forming the layer of plated metal during operation of the redox flow battery system in a charging mode and wherein the metal is oxidized to dissolve in the electrolyte during operation of the redox flow battery system in a discharging mode. In a second example of the system, optionally including the first example, the metal is oxidized and dissolves in the electrolyte during operation of the redox flow battery system in the short-term idle mode. In a third example of the system, optionally including one or both of the first and second examples, an amount of the metal that dissolves during operation of the redox flow battery system in the short-term idle mode is less than an amount of the metal that dissolves during operation of the redox flow battery system in the discharging mode. In a fourth example of the system, optionally including one or more or each of the first through third examples, an amount of the metal that dissolves in the electrolyte during operation of the redox flow battery system in the short-term idle mode is less that an amount of the metal that is plated onto the bipolar plate during operation of the redox flow battery system in the charging mode.

The disclosure also provides support for a method for operating a redox flow battery system in an idle state, comprising: responsive to a set idle duration less than a maximum idle duration, discharging a constant current density over the set idle duration to mitigate cracking and/or flaking of a plating layer at a negative electrode of the redox flow battery system. In a first example of the method, discharging the maximum idle duration is calculated based on a state of charge of the redox flow battery system and the constant current density. In a second example of the method, optionally including the first example, discharging the constant current density includes comparing the set idle duration to the maximum idle duration. In a third example of the method, optionally including one or both of the first and second examples, comparing the set idle duration to the maximum idle duration includes adjusting operation of the redox flow battery system to a long-term idle mode when the set idle duration is greater than the maximum idle duration. In a fourth example of the method, optionally including one or more or each of the first through third examples, discharging the constant current density includes monitoring the set idle duration using a timer. In a fifth example of the method, optionally including one or more or each of the first through fourth examples, discharging the constant current density includes terminating the discharging when the set idle duration ends. In a sixth example of the method, optionally including one or more or each of the first through fifth examples, the method further comprises: responsive to an unknown set idle duration adjusting operation of the redox flow battery system to a long-term idle mode.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a redox flow battery, comprising:
operating the redox flow battery in a short-term idle mode by discharging the redox flow battery at a constant current density over a duration of the short-term idle mode, wherein discharging the redox flow battery maintains a plating surface at a negative electrode of the redox flow battery.

2. The method of claim 1, wherein operating the redox flow battery in the short-term idle mode includes adjusting an operating mode of the redox flow battery to a state where the redox flow battery is not charging or discharging.

3. The method of claim 1, wherein operating the redox flow battery in the short-term idle mode includes adjusting operation of the redox flow battery to an idle state for a set idle duration.

4. The method of claim 3, wherein adjusting operation of the redox flow battery to the idle state for the set idle duration includes operating the redox flow battery in the idle state for a duration equal to or less than 6 hours.

5. The method of claim 3, wherein adjusting operation of the redox flow battery to the idle state includes adjusting an electrolyte temperature and adjusting an electrolyte flow rate.

6. The method of claim 1, wherein discharging the redox flow battery at the constant current density includes discharging current at a current density lower than a current density of current discharge used during operation of the redox flow battery in a discharge mode.

7. The method of claim 1, wherein discharging the redox flow battery at the constant current density includes discharging at a current density between 0 mA/cm² and 5 mA/cm².

8. The method of claim 1, wherein discharging the redox flow battery at the constant current density includes sacrificing a corresponding amount of metal plated at the negative electrode.

9. A redox flow battery system, comprising:
a battery cell including a negative electrode, a positive electrode, and an electrolyte;
a bipolar plate electrically coupled to the negative electrode having a layer of plated metal over at least one surface of the bipolar plate; and
a controller, including executable instructions stored on non-transitory memory that, when executed, cause the controller to:
continuously discharge a current density in response to operation of the redox flow battery system in a short-term idle mode.

10. The redox flow battery system of claim 9, wherein the bipolar plate is configured to receive a metal forming the layer of plated metal during operation of the redox flow battery system in a charging mode and wherein the metal is oxidized to dissolve in the electrolyte during operation of the redox flow battery system in a discharging mode.

11. The redox flow battery system of claim 10, wherein the metal is oxidized and dissolves in the electrolyte during operation of the redox flow battery system in the short-term idle mode.

12. The redox flow battery system of claim 11, wherein an amount of the metal that dissolves during operation of the redox flow battery system in the short-term idle mode is less than an amount of the metal that dissolves during operation of the redox flow battery system in the discharging mode.

13. The redox flow battery system of claim 10, wherein an amount of the metal that dissolves in the electrolyte during operation of the redox flow battery system in the short-term idle mode is less that an amount of the metal that is plated onto the bipolar plate during operation of the redox flow battery system in the charging mode.

14. A method for operating a redox flow battery system in an idle state, comprising:
responsive to a set idle duration less than a maximum idle duration;
discharging a constant current density over the set idle duration to mitigate cracking and/or flaking of a plating layer at a negative electrode of the redox flow battery system.

15. The method of claim 14, wherein discharging the maximum idle duration is calculated based on a state of charge of the redox flow battery system and the constant current density.

16. The method of claim 15, wherein discharging the constant current density includes comparing the set idle duration to the maximum idle duration.

17. The method of claim 16, wherein comparing the set idle duration to the maximum idle duration includes adjusting operation of the redox flow battery system to a long-term idle mode when the set idle duration is greater than the maximum idle duration.

18. The method of claim 14, wherein discharging the constant current density includes monitoring the set idle duration using a timer.

19. The method of claim 14, wherein discharging the constant current density includes terminating the discharging when the set idle duration ends.

20. The method of claim 14, further comprising responsive to an unknown set idle duration adjusting operation of the redox flow battery system to a long-term idle mode.
